(19) United States
(12) Patent Application Publication
(10) Pub. No.: US 2025/0037499 A1
(43) Pub. Date: Jan. 30, 2025

(54) METHOD AND APPARATUS FOR PROCESSING IDENTITY RECOGNITION IMAGE, COMPUTER DEVICE, AND STORAGE MEDIUM

(71) Applicant: TENCENT TECHNOLOGY (SHENZHEN) COMPANY LIMITED, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN); Hang ZHOU, Shenzhen (CN); Xiaojie CHEN, Shenzhen (CN); Ruixin ZHANG, Shenzhen (CN); Yingyi ZHANG, Shenzhen (CN)

(21) Appl. No.: 18/918,232

(22) Filed: Oct. 17, 2024

Related U.S. Application Data
(63) Continuation of application No. PCT/CN2023/124940, filed on Oct. 17, 2023.

(30) Foreign Application Priority Data
Nov. 2, 2022 (CN) 202211363284.1

(51) Int. Cl. G06V 40/12; G06V 10/32

(52) U.S. Cl. CPC G06V 40/1347; G06V 10/32; G06V 40/1365

(57) ABSTRACT

A method includes obtaining a current image for a target object, recognizing a target image region from the current image, determining an imaging size of the target object based on the target image region, obtaining a reference parameter determined according to a reference size of the target object and a reference distance between aperture and image sensor of camera, determining first distance between the target object and the camera when the current image is collected based on the reference parameter and the imaging size, obtaining second distance between the target object and the camera when historical image is collected, determining collection time difference between the current and historical images, determining movement speed of the target object based on the first and second distances, and the collection time difference, and determining, according to the current image, target image when the movement speed satisfies identity recognition image condition.

### CROSS-REFERENCE TO RELATED APPLICATIONS

This application is a continuation of International Application No. PCT/CN2023/124940, which claims priority to Chinese Patent Application No. 202211363284.1, filed on Nov. 2, 2022 and entitled “METHOD AND APPARATUS FOR PROCESSING IDENTITY RECOGNITION IMAGE, COMPUTER DEVICE, AND STORAGE MEDIUM,” which are incorporated herein by reference in their entirety.

### FIELD OF THE TECHNOLOGY

This application relates to the field of computer technologies, and in particular, to a method and an apparatus for processing an identity recognition image, a computer device, a storage medium, and a computer program product.

### BACKGROUND OF THE DISCLOSURE

With the development of computer technologies, identity recognition technologies that are more and more mature are widely applied in various fields such as business cooperation, consumer payment, social media, and security and access control. Identity recognition is a process of recognizing real identity information of a user. Implementations of identity recognition are more and more diversified, including, for example, identity recognition based on QR codes and identity recognition based on biometric features. Identity recognition based on biometric features refers to identity recognition using inherent biometric features of human, such as a hand shape, a fingerprint, a face shape, a retina, and an auricle, which has become a development trend of the identity recognition technologies.

In the related art, when identity recognition is performed, an image configured for identity recognition needs to be obtained. However, an image with poor quality is often obtained, resulting in low accuracy of identity recognition.

### SUMMARY

In accordance with the disclosure, there is provided a processing method including obtaining a current image collected for a target object that includes an identity feature, recognizing, from the current image, a target image region in which the target object is located, determining an imaging size of the target object based on the target image region, obtaining a reference parameter determined according to a reference size of the target object and a reference distance between an aperture of a camera that captured the current image and an image sensor of the camera, determining a first distance between the target object and the camera when the current image is collected based on the reference parameter and the imaging size, obtaining a second distance between the target object and the camera when a historical image is collected for the target object, determining a collection time difference between the current image and the historical image, determining a movement speed of the target object based on the first distance, the second distance, and the collection time difference, and determining, according to the current image, a target image configured for identity recognition in response to the movement speed satisfying an identity recognition image condition.

Also in accordance with the disclosure, there is provided a computer device including at least one memory storing one or more computer-readable instructions, and at least one processor configured to execute the one or more computer-readable instructions to obtain a current image collected for a target object that includes an identity feature, recognize, from the current image, a target image region in which the target object is located, determine an imaging size of the target object based on the target image region, obtain a reference parameter determined according to a reference size of the target object and a reference distance between an aperture of a camera that captured the current image and an image sensor of the camera, determine a first distance between the target object and the camera when the current image is collected based on the reference parameter and the imaging size, obtain a second distance between the target object and the camera when a historical image is collected for the target object, determine a collection time difference between the current image and the historical image, determine a movement speed of the target object based on the first distance, the second distance, and the collection time difference, and determine, according to the current image, a target image configured for identity recognition in response to the movement speed satisfying an identity recognition image condition.

Also in accordance with the disclosure, there is provided a non-transitory computer-readable storage medium storing one or more computer-readable instructions that, when executed by at least one processor, cause the at least one processor to obtain a current image collected for a target object that includes an identity feature, recognize, from the current image, a target image region in which the target object is located, determine an imaging size of the target object based on the target image region, obtain a reference parameter determined according to a reference size of the target object and a reference distance between an aperture of a camera that captured the current image and an image sensor of the camera, determine a first distance between the target object and the camera when the current image is collected based on the reference parameter and the imaging size, obtain a second distance between the target object and the camera when a historical image is collected for the target object, determine a collection time difference between the current image and the historical image, determine a movement speed of the target object based on the first distance, the second distance, and the collection time difference, and determine, according to the current image, a target image configured for identity recognition in response to the movement speed satisfying an identity recognition image condition.

### BRIEF DESCRIPTION OF THE DRAWINGS

To describe the technical solutions in embodiments of this application more clearly, the following briefly introduces the accompanying drawings. Apparently, the accompanying drawings in the following description show only some embodiments of this application, and a person of ordinary skill in the art may still derive other drawings from the disclosed accompanying drawings without creative efforts.

FIG. 1 is a diagram showing an application environment of a method for processing an identity recognition image according to an embodiment.

FIG. 2 is a schematic flowchart of a method for processing an identity recognition image according to an embodiment.

FIG. 3 is a schematic diagram showing a detection process of a target detection model according to an embodiment.

FIG. 4 is a schematic diagram showing performing target detection by using a target detection model according to an embodiment.

FIG. 5 is a diagram showing a principle of imaging involved in a method for processing an identity recognition image according to an embodiment.

FIG. 6 is a schematic diagram showing a relationship between a target object and imaging according to an embodiment.

FIG. 7 is a schematic flowchart of determining an imaging size according to an embodiment.

FIG. 8 is a schematic diagram showing key points obtained by performing key point detection on a palm according to an embodiment.

FIG. 9 is a schematic diagram showing movement of a target object in a three-dimensional space according to an embodiment.

FIG. 10 is a schematic diagram showing target key points selected for a target object according to an embodiment.

FIG. 11 is a schematic diagram showing a prediction process of a key point detection model according to an embodiment.

FIG. 12 is a schematic diagram showing a relationship between a target object and imaging at a first calibration distance according to an embodiment.

FIG. 13 is a schematic diagram showing a relationship between a target object and imaging at a second calibration distance according to an embodiment.

FIG. 14 is a schematic diagram showing main procedures in a palm scanning payment scenario according to an embodiment.

FIG. 15 is a structural block diagram of an apparatus for processing an identity recognition image according to an embodiment.

FIG. 16 is a diagram showing an internal structure of a computer device according to an embodiment.

FIG. 17 is a diagram showing an internal structure of a computer device according to an embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

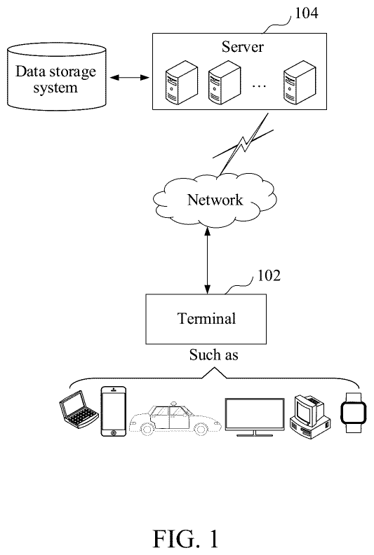

A method for processing an identity recognition image provided in the embodiments of this application may be applied to an application environment shown in FIG. 1. A terminal 102 communicates with a server 104 through a network. A data storage system may store data that the server 104 needs to process. The data storage system may be integrated on the server 104, or may be placed on a cloud or another server. The terminal 102 may obtain a current image collected for a target object including an identity feature, recognize an image region in which the target object is located from the current image, determine an imaging size of the target object based on the image region in which the target object is located, and determine, based on a pre-calibrated reference parameter and the imaging size, a first distance between the target object and a camera when the current image is collected. The reference parameter may be determined according to a reference size of the target object and a reference distance between an aperture of the camera and an image sensor. Further, the terminal may obtain a second distance, where the second distance is a distance between the target object and the camera when a historical image is collected for the target object, determine a collection time difference between the current image and the historical image, determine a movement speed of the target object based on the first distance, the second distance, and the collection time difference, and when the movement speed satisfies an identity recognition image condition, determine, according to the current image, a target image configured for identity recognition. The terminal 102 may transmit the target image to the server 104. The server 104 may perform identity recognition according to the target image.

In addition, the method for processing an identity recognition image may alternatively be separately implemented by the terminal 102. To be specific, after determining the target image, the terminal 102 may directly perform identity recognition according to the target image. The method for processing an identity recognition image may alternatively be separately implemented by the server 104. To be specific, after receiving the current image that is collected for the target object and that is uploaded by the terminal, the server determines the target image according to the current image, and then performs identity recognition according to the target image.

The terminal 102 may be, but is not limited to, various desktop computers, notebook computers, smart phones, tablet computers, internet of things devices, and portable wearable devices. The internet of things device may be a smart speaker, a smart television, a smart air conditioner, a smart vehicle-mounted device, or the like. The portable wearable device may be a smart watch, a smart bracelet, a head-mounted device, or the like. The terminal 102 may be equipped with a camera to collect images. The server 104 may be implemented as an independent server or a server cluster including a plurality of servers. The plurality of servers involved may form a blockchain, and the server 104 may be a node on the blockchain.

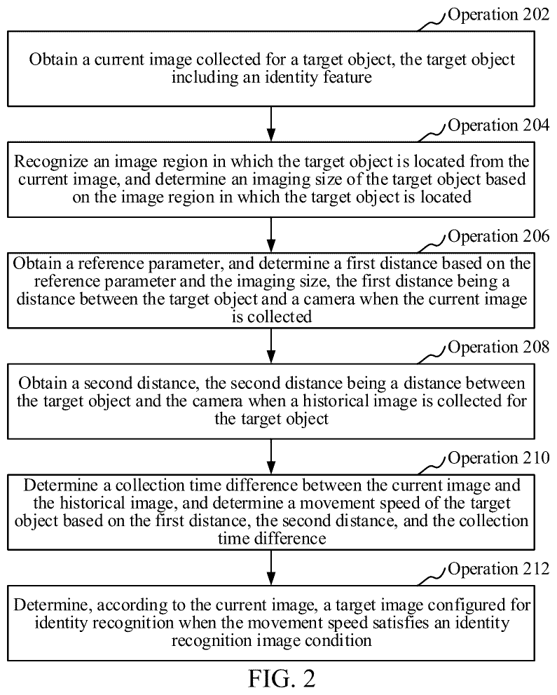

In an embodiment, as shown in FIG. 2, a method for processing an identity recognition image is provided. The method is performed by a computer device, and specifically, may be separately performed by the computer device such as a terminal or a server, or may be jointly performed by the terminal and the server. In this embodiment of this application, an example in which the method is applied to the terminal in FIG. 1 is used for description, and the method includes the following operations.

Operation 202: Obtain a current image collected for a target object, the target object including an identity feature.

Identity recognition is a process of recognizing real identity information of a user, and may further specifically verify whether the real identity information of the user is consistent with identity information purported by the user. For example, in an access control scenario, when identity recognition is performed, a user identity may be recognized, to determine whether the user is a legitimate user, thereby determining whether the user is allowed to enter. The identity feature is a feature that can be configured for identity recognition. The identity feature may include a biometric feature, such as a hand shape, a fingerprint, a face shape, a retina, or an auricle. The identity feature may further include an identity credential feature, for example, may be a QR code feature. The target object is an object including the identity feature. The target object may be specifically an object including the biometric feature, for example, a human body or a human body part. The human body part may be, for example, any one of a palm, a human face, or a sole of a foot. The target object may alternatively be an object including an identity credential feature, for example, may be a QR code image.

The terminal may obtain the current image collected for the target object. In a specific implementation, the current image may be directly collected by the terminal, or collected by another terminal and transmitted to the terminal.

Operation 204: Recognize an image region in which the target object is located from the current image, and determine an imaging size of the target object based on the image region in which the target object is located.

The image region in which the target object is located is an image region including the target object, and is also referred to as a “target image region.” For example, when the target object is a palm, a region in which the target object is located is a palm region in the image. The image region in which the target object is located may be a region in any shape, for example, a matrix, a square, or a circle, provided that the target object can be framed. A shape of the region is not limited in this embodiment. The imaging size is configured for representing an imaging size of the target object in the image. When the target object is at a different distance from the camera, the imaging size of the target object in the image is different. Generally, a smaller distance between the target object and the camera indicates larger imaging of the target object in the image, that is, the imaging size is larger; and a larger distance between the target object and the camera indicates smaller imaging of the target object in the image, that is, the imaging size is smaller. The imaging size of the target object may be specifically a parameter value of the imaging size of the target object in the image. In some embodiments, the parameter value of the imaging size of the target object in the image may be a value representing a width of the imaging of the target object in the image.

The terminal may perform target detection on the current image, to recognize the image region in which the target object is located from the current image. Because the image region in which the target object is located is recognized, the imaging size of the target object may be subsequently determined based on the image region in which the target object is located, thereby avoiding interference of irrelevant content in the current image.

In an embodiment, the terminal may obtain a training sample including the target object, calibrate position information of the target object in the training sample, for example, may calibrate position information of a rectangular frame in which the target object is located, and then train a to-be-trained target detection model by using the training sample. After training is completed, a trained target detection model is obtained. The terminal may obtain the trained target detection model during identity recognition, input the current image into the trained target detection model, output the position information of the target object in the current image through the target detection model, and then determine the image region in which the target object is located. The target detection model may be a model of a region-convolutional neural network (CNN) series of region proposal algorithms, for example, may be an R-CNN model, a fast R-CNN model, a faster R-CNN model, or a model based on a region-free algorithm, for example, may be a Yolo model or an SSD model. The Yolo model is used as an example for description below.

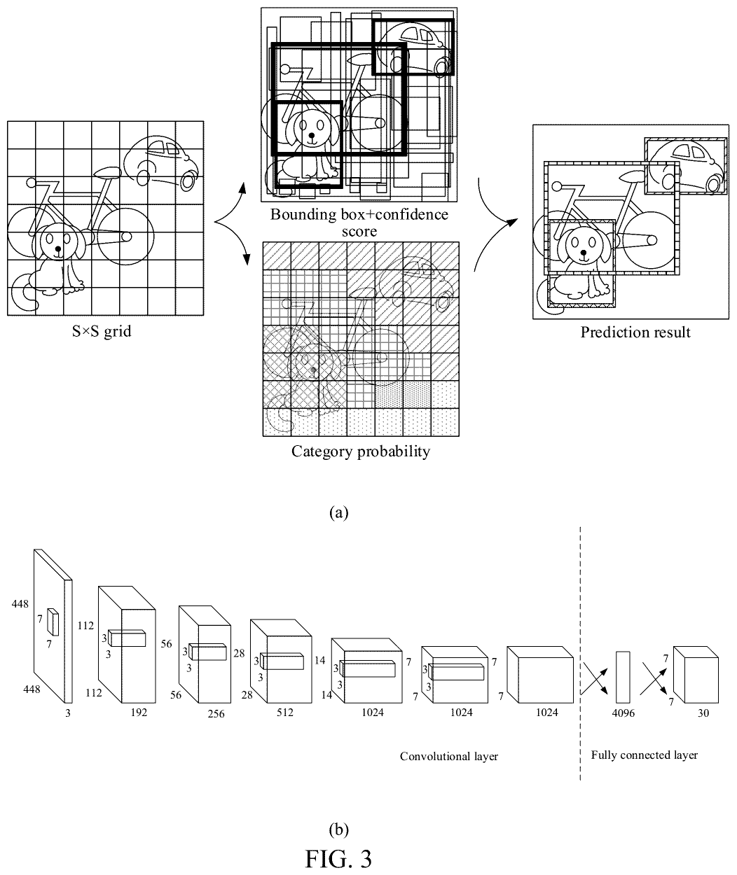

Part (a) of FIG. 3 shows a detection process of a Yolo model. A convolutional network of the Yolo model segments an input picture into S×S grids, and detects, for each unit grid, a target whose center point falls within the grid. Each unit grid predicts B bounding boxes and a confidence score of a bounding box. The confidence score includes two aspects: first, a probability that the bounding box includes the target, and second, accuracy of the bounding box. The probability that the bounding box includes the target is denoted as Pr(object). When the bounding box is a background (that is, the bounding box does not include a target), Pr(object)=0. When the bounding box includes the target, Pr(object)=1. The accuracy of the bounding box may be represented by an intersection over union (IOU) between a prediction box and an actual box (ground truth). Therefore, the confidence score may be defined as Pr(object)*IOU. A size and a position of the bounding box may be represented by four values: (x, y, w, h), where (x, y) are center coordinates of the bounding box, and w and h are a width and a height of the bounding box. Predicted values (x, y) of the center coordinates are offset values relative to a coordinate point at an upper left corner of each unit grid, and a unit is relative to a size of the unit grid. Predicted values of w and h of the bounding box are relative to a ratio of a width to a height of an entire picture. Values of the four elements need to be in a range of [0, 1]. In this way, the predicted values of each bounding box actually includes five elements: (x, y, w, h, c), where the first four values represent the size and the position of the bounding box, and the last value is the confidence score. In addition, a category probability value is further predicted for each unit grid, and represents probabilities that a target of a bounding box predicted by the unit grid belongs to each category. These probability values are conditional probabilities under confidence scores of the bounding boxes. According to the bounding box, the confidence score, and the category probability value, positions and categories of the targets in an input image can be finally predicted.

Part (b) of FIG. 3 shows a network structure of a Yolo model. As shown in part (b) of FIG. 3, a convolutional network is used in Yolo to extract a feature, and then a fully connected layer is used, to obtain a predicted value. For a network structure, reference is made to a GooLeNet model, including 24 convolutional layers and 2 fully connected layers. For the convolutional layer, 1×1 convolution is mainly used for channel reduction, and then 3×3 convolution immediately is subsequently used. For the convolutional layer and the fully connected layer, Leaky ReLU is used for activation, and for the last layer, a linear activation function is used.

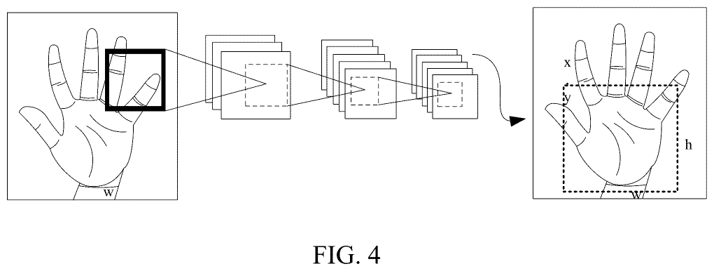

In a specific embodiment, FIG. 4 is a schematic diagram showing performing target detection by using a target detection model. In this embodiment, a target object is a palm. An input image input into the target detection model in FIG. 4 is a current image collected for the palm. The target detection model adjusts the current image to a size matching an input of the model. The target detection model performs convolution processing on an adjusted image by using a convolutional neural network. A region in which a box is located in an output image of the target detection model is a region in which the palm is located.

In a specific embodiment, when a terminal performs target detection on the current image by using a trained Yolo model, an imaging size of the target object may be a width w of a bounding box obtained by the Yolo model.

Operation 206: Obtain a reference parameter, and determine a first distance based on the reference parameter and the imaging size, the first distance being a distance between the target object and a camera when the current image is collected.

The reference parameter is a parameter used as a reference to calculate the distance between the target object and the camera. In this disclosure, the distance between the target object and the camera is also referred to as an “object distance.” For example, the first distance is also referred to as a “first object distance.” The reference parameter is determined according to a reference size of the target object and a reference distance between an aperture of the camera and an image sensor. The reference parameter may be directly determined according to the reference size of the target object and the reference distance between the aperture of the camera and the image sensor. To be specific, the terminal may obtain a specific reference size and a specific reference distance, and calculate the reference parameter based on the reference size and the reference distance. The reference parameter is indirectly determined according to the reference size of the target object and the reference distance between the aperture of the camera and the image sensor. In an indirect determining process, the reference parameter is calibrated by using only the two parameters, but the reference parameter does not need to be calculated according to specific values of the two parameters.

The reference size of the target object is configured for representing an actual size of the target object, and a specific expression parameter of the reference size may be selected as required. Both the imaging size of the target object and the reference size of the target object may be selected as required, but it needs to be ensured that the imaging size and the reference size correspond to each other, that is, a parameter selected for the imaging size needs to be consistent with a parameter selected for the reference size. For example, assuming that a value for representing an actual width of the target object is selected for the reference size, the imaging size is a value representing a width of the actual width in the image during imaging. The reference distance between the aperture of the camera and the image sensor is an actual physical distance between the camera in the terminal and the image sensor. After the camera in the terminal is determined, the reference distance is usually fixed.

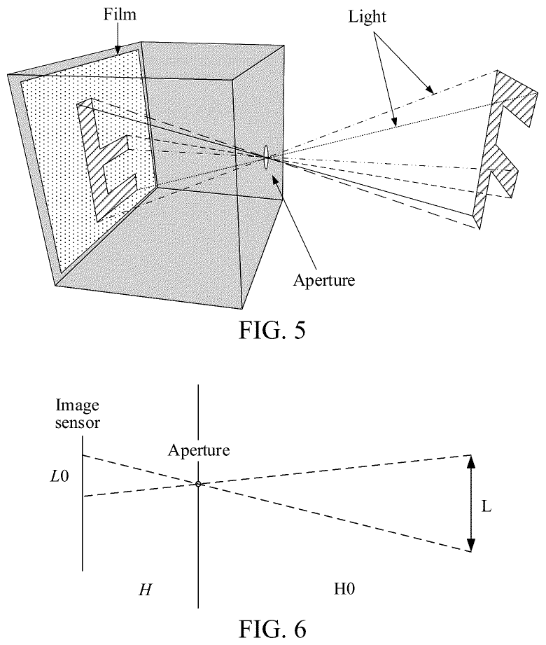

That the camera performs image collection on the target object may be similar to pinhole imaging. FIG. 5 is a diagram showing a principle of imaging according to an embodiment of this application. After light enters through the aperture of the camera, an upside-down image appears on a film of the camera. Based on this, a relationship between the target object and the imaging can be obtained. FIG. 6 is a schematic diagram showing a relationship between a target object and imaging. Assuming that a reference size of the target object is L, an imaging size is L0, and a reference distance between an aperture in a camera and an image sensor is H, the following Formula (1) can be obtained:

$$\frac{L}{H 0} = \frac{L 0}{H} \qquad Formula ( 1 )$$

In Formula (1), H0 is a distance between the target object and the camera, and it can be obtained from Formula (1) that L×H=H0×L0. Considering that sizes of different target objects usually do not differ greatly, it is assumed that the reference size L of the target object is a fixed value, and a reference distance H0 between the aperture of the camera and the image sensor is also a fixed value. Therefore, a reference parameter may be pre-calculated according to the reference size L and the reference distance H0 between the aperture of the camera and the image sensor. Assuming that the reference parameter is K, in an actual application process, after an imaging size X of the target object is determined according to an image region in which the target object is located in a current image, the distance H=K/X between the target object and the camera when the current image is collected can be calculated according to K. In some embodiments, the distance between the target object and the camera may be specifically a distance between the target object and the aperture of the camera.

Operation 208: Obtain a second distance, the second distance being a distance between the target object and the camera when a historical image is collected for the target object.

The second distance is the distance between the target object and the camera when the historical image is collected for the target object. The historical image is a previous image, that is, an image collected before the current image. The historical image may be, for example, a previous image of the current image, or an image before the previous image, or any historical image that is collected at a time interval within a preset time period. Specifically, the historical image may be obtained as required. When the camera collects images, a time interval between two adjacent images may be set as required. To ensure accuracy of estimation of a movement speed, a collection time difference between the two images needs to be less than a preset threshold. For example, the time difference between the two images may be 40 ms.

The terminal may obtain the second distance, and then estimate the movement speed of the target object based on the first distance and the second distance. In a specific embodiment, the second distance may be calculated in the same manner in which the first distance is calculated. In other embodiments, the second distance may alternatively be calculated in a manner different from a manner in which the first distance is calculated, provided that the distance between the target object and the camera can be obtained when the historical image is collected for the target object. For example, a component configured to fix the target object may be arranged at a preset position above the terminal, and the distance between the target object and the camera at the preset position can be obtained by measurement in advance, so that the second distance can be obtained by measurement in advance.

The cameras mentioned above refer to a camera in the same computer device. The camera may be specifically a camera in the computer device that collects the current image for the target object. In some embodiments, when the computer device that collects the current image for the target object is a terminal configured to perform identity recognition, the reference distance configured for determining the reference parameter is a distance between the aperture of the camera in the terminal and the image sensor. The first distance is a distance between the target object and the camera in the terminal when the terminal collects the current image. The second distance is a distance between the target object and the camera in the terminal when the terminal collects the historical image for the target object.

Operation 210: Determine a collection time difference between the current image and the historical image, and determine the movement speed of the target object based on the first distance, the second distance, and the collection time difference.

The collection time difference is a time difference between a time point at which the current image is collected and a time point at which the historical image is collected. For example, if the time point at which the current image is collected is t1, and the time point at which the historical image is collected is t2, the collection time difference is t2-t1.

After obtaining the first distance between the target object and the camera when the current image is collected and the second distance between the target object and the camera when the historical image is collected for the target object, the terminal can obtain a distance difference between the second distance and the first distance, and then can determine the movement speed of the target object based on the distance difference and the collection time difference. For details, reference may be made to the following Formula (2), where ΔH is a distance difference between the second distance and the first distance, Δt is the collection time difference, and v is the movement speed.

$$v = \frac{Δ H}{Δ f} \qquad Formula ( 2 )$$

Operation 212: Determine, according to the current image, a target image configured for identity recognition when the movement speed satisfies an identity recognition image condition.

The identity recognition image condition is a preset condition configured for determining an identity recognition image, and the identity recognition image is an image that can be configured for identity recognition. In some embodiments, the identity recognition image condition may be: the movement speed is required to be less than or equal to a preset speed threshold. Alternatively, in some embodiments, the identity recognition image condition may be: the movement speed is required to be a small movement speed in a plurality of movement speeds determined consecutively. For example, assuming that five images are collected for the target object, and the movement speed is obtained according to operation 202 to operation 210 for every two adjacent images respectively, when a fifth image is collected, that the movement speed satisfies the identity recognition image condition may be that an obtained movement speed is a minimum value of all the movement speeds. The target image is an image that can be directly configured for identity recognition. In specific application, the target image may be a current image that satisfies the identity recognition image condition, or the target image may be selected from a plurality of images that satisfy the identity recognition image condition.

After determining the movement speed of the target object, the terminal may determine whether the movement speed satisfies the identity recognition image condition. If the movement speed satisfies the identity recognition image condition, the terminal may determine the target image configured for identity recognition according to the current image. In a specific implementation, the terminal may directly use the current image as the target image. The terminal may alternatively save the current image, and after obtaining a plurality of images satisfying the identity recognition image condition, the terminal may select the target image from these images. For example, the terminal may select an image with an imaging size corresponding to the target object within a specific range from the images, and filter out an image with an excessively large imaging size or an excessively small imaging size.

In a specific embodiment, operation 202 to operation 208 are implemented in a registration stage before the identity recognition. In this case, the terminal may further extract identity registration information from the target image, and store the identity registration information corresponding to an identity identifier of a current registered user. In another specific embodiment, operation 202 to operation 208 may be implemented in an identity recognition process. In this case, the terminal may further perform identity recognition according to the target image.

In the foregoing method for processing an identity recognition image, the current image collected for the target object is obtained. The target object includes the identity feature. The image region in which the target object is located is recognized from the current image, the imaging size of the target object is determined based on the image region in which the target object is located, the first distance between the target object and the camera when the current image is collected is determined based on a pre-calibrated reference parameter and the imaging size. The reference parameter is determined according to the reference size of the target object and the reference distance between the aperture of the camera and the image sensor. The second distance is obtained. The second distance is a distance between the target object and the camera when the historical image is collected for the target object. The collection time difference between the current image and the historical image is determined. The movement speed of the target object is determined based on the first distance, the second distance, and the collection time difference. When the movement speed satisfies the identity recognition image condition, the target image configured for identity recognition is determined according to the current image. Since when the current image is collected, the movement speed of the target object satisfies the identity recognition image condition, movement blur that occurs in an image configured for identity recognition due to an excessively fast movement speed can be avoided, so that quality of the image configured for identity recognition is improved, thereby improving accuracy of identity recognition. Further, since the movement speed of the target object in the identity recognition process is estimated without additional hardware such as a distance sensor. While the accuracy of identity recognition is improved, costs required for identity recognition are further reduced.

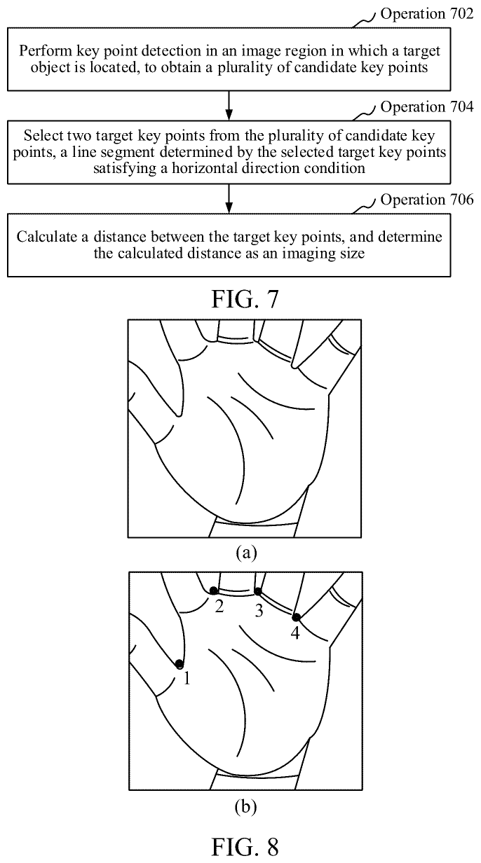

In an embodiment, as shown in FIG. 7, the imaging size of the target object is determined based on the image region in which the target object is located, and the method includes the following operations.

Operation 702: Perform key point detection in the image region in which the target object is located, to obtain a plurality of candidate key points.

In a process in which the target object approaches the camera, due to angular image distortion and the like, sizes of image regions in which the target object is located at different distances may be inaccurate. Based on this, precise positions of several points that are relatively fixed in the target object need to be obtained through key point detection, to avoid a problem of the inaccurate sizes of the image regions caused by posture interference.

In a specific embodiment, the terminal may perform, through a trained key point detection model, key point detection on the image region in which the target object is located, to obtain the plurality of candidate key points. Specifically, a training sample including a target object may be obtained, position information of key points is calibrated in the training sample, and then a to-be-trained key point detection model is trained by using the training sample. After training is completed, the trained key point detection model is obtained, so that the terminal can obtain the trained key point detection model, crop the image region in which the target object is located from the current image, input the cropped image into the trained key point detection model, and output, by using the key point detection model, position information of the candidate key points, to determine the candidate key points. FIG. 8 is a schematic diagram showing key points obtained by performing key point detection on a palm. Part (a) in FIG. 8 is an image of a region in which a palm is located that is obtained by being cropped from a current image, and part (b) in FIG. 8 shows several candidate key points obtained by performing key point detection on the image, specifically including the key points indicated by 1, 2, 3, and 4 in part (b).

Operation 704: Select two target key points from the plurality of candidate key points, a line segment determined by the selected target key points satisfying a horizontal direction condition.

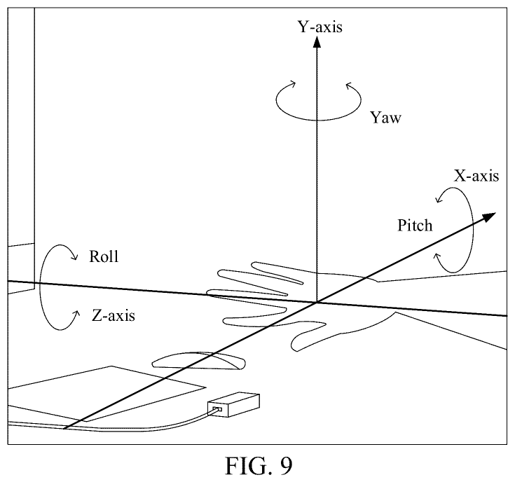

In a three-dimensional space, the target object usually moves in three directions. Refer to FIG. 9, that the target object is a palm is used for description. The three directions include: rotating around an X-axis, namely, a pitch movement, rotating around a Y-axis, namely, a yaw movement, and rotating around a Z-axis, namely, a roll movement. In a process of collecting the current image for the target object, the yaw movement of the target object does not cause image distortion. Because the target object is flush with a plane of an image collection device by default, the roll movement may be ignored. To be specific, a degree of freedom of movement of the target object is generally in a pitch direction. To effectively avoid image distortion caused by movement in the pitch direction, after the terminal obtains the plurality of candidate key points, the terminal may select two target key points that satisfy the horizontal direction condition from the plurality of candidate key points, to determine the imaging size. The target key points satisfy the horizontal direction condition, that is, a line segment formed by the selected two target key points (i.e., a line segment connecting the selected two target key points) is close to a horizontal direction, where being close to the horizontal direction may be that an angle between the line segment and the horizontal direction is less than a preset threshold. In a specific embodiment, when the target object is a human face part, the candidate key points are facial key points, which may be specifically key points of eyes, a mouth, an ear, and the like, and the target key points may be key points at positions of two eyes.

In actual application, when the candidate key points of the target object include a plurality of groups of target key points that satisfy the horizontal direction condition, it needs to be ensured that the selected target key points are consistent with a reference size of the calibrated target object.

Operation 706: Calculate a distance between the target key points, and determine the calculated distance as the imaging size of the target object.

The terminal may calculate the distance between the target key points, namely, a length of the line segment formed by the target key points, and determine the calculated distance as the imaging size.

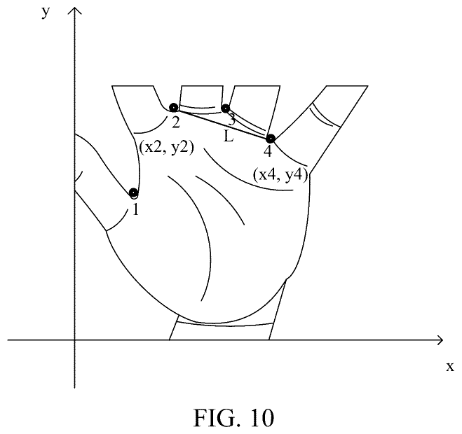

In a specific embodiment, referring to FIG. 10, the target object is a palm, the selected target key points may be key points 2 and 4 shown in FIG. 10, and the imaging size is a distance between the key points 2 and 4, namely, a length of a line segment formed by the key points 2 and 4. It is assumed that coordinates of the two target key points 2 and 4 are (x2, y2) and (x4, y4) respectively. The terminal may calculate a distance L between the target key points according to the following Formula (3), and determine the calculated distance as the imaging size.

$$L = \sqrt{{( x 2 - x 4 )}^{2} + {( y 2 - y 4 )}^{2}} \qquad Formula ( 3 )$$

In this embodiment, key point detection is performed on the image region in which the target object is located, to obtain the plurality of candidate key points, and two target key points are selected from the plurality of candidate key points. Since the line segment determined by the target key points satisfies the horizontal direction condition, impact of movement of the target object on the image distortion can be effectively avoided. Therefore, the distance between the target key points is calculated, and the calculated distance is determined as the imaging size, so that the accuracy of the imaging size can be improved.

In an embodiment, that the key points are detected in the image region in which the target object is located, to obtain the plurality of candidate key points includes: extracting the image region in which the target object is located from the current image, to obtain a to-be-detected image (also referred to as a “detection-target image” or “detection image”), and inputting the to-be-detected image into a trained target key point detection model, to obtain an initial key point predicted by using the target key point detection model; cropping, from the to-be-detected image, a region image within a preset range around the initial key point, to obtain a cropped image; enlarging the cropped image according to an image size specified by the target key point detection model, to obtain an enlarged image; and inputting the enlarged image into the target key point detection model, to obtain the plurality of candidate key points.

The target key point detection model is a machine learning model for key point detection, and may be obtained through supervised training. The target key point detection model may be a model based on a DeepPose algorithm. The idea of the DeepPose algorithm is to change a key point detection algorithm into a purely mathematical prediction problem without considering a somatology problem in a complex posture. A more general end-to-end key point detection algorithm is implemented by manually annotating a large amount of human key point data in various postures, and by learning sample data through deep neural networks (DNNs).

The terminal may extract the image region in which the target object is located from the current image, to obtain the to-be-detected image, and input the to-be-detected image into the trained target key point detection model. After the target key point detection model performs a series of convolution on the input to-be-detected image, a plurality of position coordinates (x, y) are further obtained through two fully connected layers. Each set of position coordinates represents one initial key point. Since a target size is not determined in the input to-be-detected image, and a size of an input image received by the target key point detection model is fixed, an error occurs in final target position prediction due to scaling of an excessively large image. Based on this, the terminal may further determine a region within the preset range around the initial key point from the to-be-detected image, crop the region from the to-be-detected image, to obtain a cropped image, then enlarge the cropped image according to an image size specified by the target key point detection model, to obtain the enlarged image, input the enlarged image into the target key point detection model again to detect the key points, and output the plurality of key points through the target key point detection model. In some embodiments, the region within the preset range around the initial position may be, for example, a rectangular box that is centered on the initial position and is of a preset size. In some embodiments, the terminal may use the key points output by the target key point detection model by performing key point detection on the enlarged image as the candidate key points.

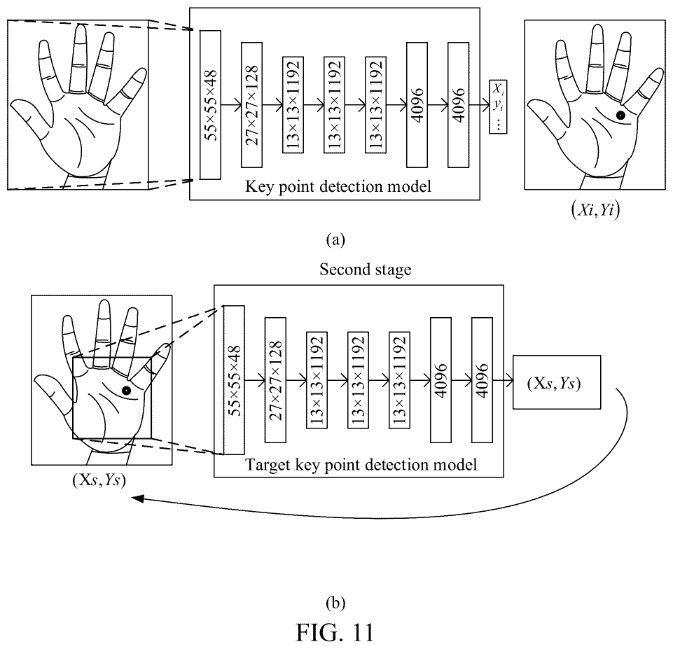

Alternatively, in some embodiments, for the current image, the terminal may perform key point detection for a plurality of times by using the target key point detection model. After a plurality of key points are obtained through each time of key point detection, the obtained key points may be used as initial key points, and the following operations are iteratively performed. In the to-be-detected image, a region image within a preset range around the initial key point is cropped, to obtain the cropped image. The cropped image is enlarged according to the image size specified by the target key point detection model, to obtain the enlarged image. The enlarged image is input into the target key point detection model, to output a plurality of key points. Each time the image is cropped and enlarged, a detailed feature of the region in which the key points are located may be enlarged. After a plurality of iterations, position points that are finally obtained are determined as the candidate key points. For example, referring to FIG. 11, in part (a) of FIG. 11, in a first stage, the terminal may first input a palm image (which is a to-be-detected image) into a trained target key point detection model, and predict an initial key point by using the key point detection model. The initial key point is a circular point in part (a), and coordinates are (Xi, Yi). In part (b) of FIG. 11, in a second stage, the terminal crops the to-be-detected image, and crops a region image within a preset range around (Xi, Yi). The region image within the preset range around (Xi, Yi) is an image in a rectangular box in part (b). The cropped region image is enlarged to a region image with a size specified by the target key point detection model, and is then input into the target key point detection model again, and coordinates of a predicted key point are (Xs, Ys). Then (Xs, Ys) is used as an initial key point in a next stage, and the operations in the second stage are repeated for preset times, to finally obtain coordinate information of the candidate key points.

In the foregoing embodiment, the initial key point is first predicted by using the trained target key point detection model, so that the region image within the preset range around the initial key point may be cropped from the to-be-detected image. The region image is enlarged and then input into the target key point detection model for prediction, and after the region around the position of the estimated key point is cropped and enlarged, more accurate prediction can be further performed, thereby improving prediction accuracy of the positions of the final candidate key points.

In an embodiment, the reference parameter is calibrated through the following operations: obtaining the reference size of the target object, and obtaining the reference distance between the aperture of the camera and the image sensor; and calculating a product of the reference size and the reference distance, to obtain the reference parameter.

Specifically, the terminal may obtain actual sizes of a plurality of target objects, and calculate an average, to obtain the reference size of the target object; obtain measurement values obtained by measuring the distance between the aperture of the camera and the image sensor for a plurality of times, and calculate an average of the measurement values, to obtain the reference distance between the aperture of the camera and the image sensor, and then calculate the product of the reference size and the reference distance, to obtain the reference parameter. In specific application, an example in which the target object is a palm is used. Assuming that a difference in sizes of palms of adults is not large, a distance between a key point 2 and a key point 4 may be measured for palms of a plurality of different adults, and then an average is calculated, to obtain a reference size of the palm. The camera mentioned herein and the camera that captures the current image may be cameras in the same computer device, or may be cameras with the same reference distance.

In the foregoing embodiment, by directly obtaining the reference size of the target object, and obtaining the reference distance between the aperture of the camera and the image sensor, the reference parameter is obtained based on the product of the reference size and the reference distance, and the reference parameter can be quickly calibrated.

In an embodiment, the reference parameter is calibrated through the following operations.

1. Obtain a first calibration image collected by using the camera, the first calibration image being an image collected for the target object at a first calibration distance. The camera that captures the first calibration image and the camera that captures the current image may be cameras in the same computer device, or may be cameras with the same reference distance.

2. Recognize the image region in which the target object is located from the first calibration image, and determine an imaging size of the target object in the first calibration image based on the image region in which the target object is located in the first calibration image, to obtain a first calibration size of the target object.

3. Calculate a product of the first calibration size and the first calibration distance, to obtain a first product calculation result of the reference size of the target object and the reference distance, and use the first product calculation result as the reference parameter.

The first calibration size is an imaging size corresponding to the target object in the first calibration image, and is configured for representing an imaging size of a first target object in the first calibration image. The first calibration distance is a distance value set in a calibration process, and the first calibration distance is a known value in a calculation process.

A first calibration distance is set. When the target object is at the position of the first distance, the terminal may perform image collection on the target object to obtain the first calibration image. The terminal further performs target detection on the first calibration image, to recognize the image region in which the target object is located, and determines the imaging size of the target object in the first calibration image based on the image region in which the target object is located in the first calibration image, to obtain the first calibration size of the target object.

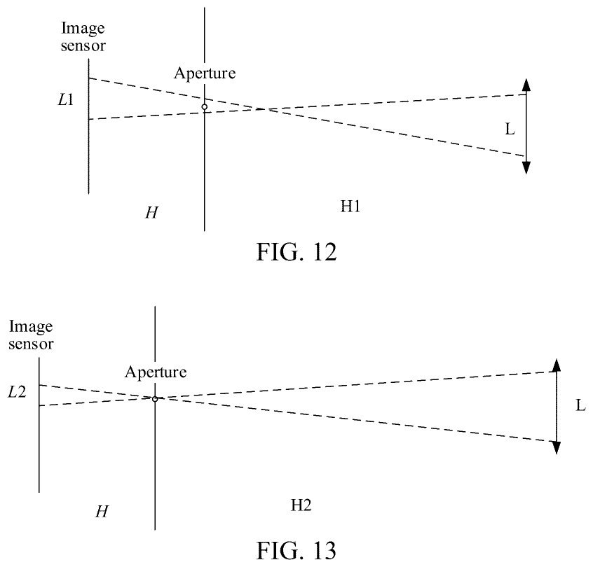

Assuming that the first calibration distance is H1, and the first calibration size corresponding to the first calibration image is L1, based on the trigonometric function correlation relationship, a schematic diagram showing a relationship between the target object and imaging at a first calibration distance shown in FIG. 12 may be obtained. According to the schematic diagram showing the relationship, the following Formula (4) may be obtained.

$$\frac{L}{H 1} = \frac{L 1}{H} \qquad Formula ( 4 )$$

Based on Formula (4), it can be obtained that L×H=H1×L1, where H1 is known, and L1 is determined. Therefore, L×H can be calculated, a product of the first calibration size L1 and the first calibration distance H1 is used as the first product calculation result obtained by multiplying the reference size L and the reference distance H in this calibration, and the first product calculation result is used as the reference parameter.

In another specific embodiment, considering that one calibration may have an error, the reference parameter may be obtained through a plurality of calibrations. A calibration operation include: obtaining a plurality of second calibration images collected by using the camera, the plurality of second calibration images being images respectively collected for the target object at different second calibration distances; recognizing, for each of the plurality of second calibration images, the image region in which the target object is located from the second calibration image; determining an imaging size of the target object in the second calibration image based on the image region in which the target object is located in the second calibration image, to obtain a second calibration size of the target object; calculating a product of the second calibration distance when the second calibration image is collected and the second calibration size, to obtain a second product calculation result of the reference size of the target object and the reference distance; and calculating a product average of second product calculation results, to obtain the reference parameter.

The second calibration size is an imaging size corresponding to the target object in the second calibration image, and is configured for representing an imaging size of a first target object in the second calibration image. The camera that captures the first calibration image and the camera that captures the current image may be cameras in the same computer device, or may be cameras with the same reference distance.

The second calibration distance is a distance value set in a calibration process, and the second calibration distance is a known value in a calculation process. In a specific implementation, a plurality of second calibration distances may be set. Each second calibration distance corresponds to one calibration. In each calibration process, when the target object is at a position of the second distance set in this calibration, the terminal may perform image collection on the target object to obtain the second calibration image. The terminal further performs target detection on the second calibration image to recognize the image region in which the target object is located, and then determines, based on the image region in which the target object is located in the second calibration image, the imaging size of the target object in the second calibration image in this calibration, to obtain the second calibration size of the target object in this calibration.

Using one calibration as an example, it is assumed that the second calibration distance is H2, and the second calibration size corresponding to the second calibration image is L2. Based on the trigonometric function correlation relationship, a schematic diagram showing a relationship between the target object and imaging at a second calibration distance shown in FIG. 13 may be obtained. According to the schematic diagram showing the relationship, the following Formula (5) may be obtained:

$$\frac{L}{H 2} = \frac{L 2}{H} \qquad Formula ( 5 )$$

Based on Formula (5), it can be obtained that L×H=H2×L2, where H2 is known, and L2 is determined. Therefore, L×H in this calibration can be calculated, that is, a product calculation result of the product of the second calibration size L2 and the second calibration distance H2 corresponding to the second calibration image is used as a second product calculation result obtained by multiplying the reference size L and the reference distance H in this calibration.

Further, the terminal may calculate a product average of a plurality of second product calculation results obtained through a plurality of calibrations, and determine the product average as the reference parameter.

The plurality of calibrations in this embodiment means two or more calibrations, and a specific number of calibrations may be set as required.

In the foregoing embodiment, the calibration image is obtained, and the target detection is performed on the calibration image, to recognize the image region in which the target object is located. The calibration size of the target object is determined based on the image region in which the target object is located in the calibration image, the product of the calibration size and the calibration distance corresponding to the calibration image is calculated, and the calculated product is determined as the product calculation result of the reference size and the reference distance. In this way, the reference parameter is determined according to an average of the product calculation results obtained through a plurality of calibrations, thereby avoiding an error in a manual measurement process and improving accuracy.

In an embodiment, a method for processing an identity recognition image is provided, and is performed by a computer device. Specifically, the method may be separately performed by a computer device such as a terminal or a server, or may be jointly performed by the terminal and the server. In this embodiment of this application, an example in which the method is applied to the terminal in FIG. 1 is used for description, and the method includes the following operations:

1. Obtain a current image collected for a target object, the target object including an identity feature.

2. Recognize an image region in which the target object is located from the current image, and determine an imaging size of the target object based on the image region in which the target object is located.

3. Obtain a reference parameter, and determine, based on a pre-calibrated reference parameter and an imaging size, a first distance between the target object and a camera when the current image is collected, the reference parameter being determined according to a reference size of the target object and a reference distance between an aperture of the camera and an image sensor.

4. Obtain a second distance, the second distance being a distance between the target object and the camera when a historical image is collected for the target object.

5. Determine a collection time difference between the current image and the historical image, and determine a movement speed of the target object based on the first distance, the second distance, and the collection time difference.

6. Determine whether the movement speed is less than or equal to a speed threshold specified by an identity recognition image condition, if yes, enter operation 8, or if no, enter operation 7.

7. Continue to collect a next image, determine the collected next image as the current image, and enter operation 2.

After the terminal enters operation 2, operation 2 to operation 7 are repeatedly performed until a candidate image is obtained.

8. Determine the current image as a candidate image, and determine the target image configured for identity recognition based on the candidate image.

The terminal may directly use the candidate image as the target image. The terminal may alternatively save the current image, continue to collect the next image, and determine the collected next image as the current image; and enter operation 2, and repeatedly perform operation 2 to operation 7, to obtain a plurality of candidate images, thereby selecting a target image from the candidate images.

In the foregoing embodiment, when the movement speed is less than the speed threshold set in the identity recognition image condition, the current image is determined as the candidate image, and the target image configured for identity recognition is determined based on the candidate image. This avoids image blur due to an excessively fast speed, thereby improving accuracy of identity recognition.

In an embodiment, the method for processing an identity recognition image further includes: obtaining the historical image collected for the target object; recognizing, from the historical image, the image region in which the target object is located in the historical image, and determining an imaging size of the target object in the historical image based on the image region in which the target object is located in the historical image; and determining, based on the reference parameter and the imaging size of the target object in the historical image, a second distance between the target object and the camera when the historical image is collected.

The terminal may input the historical image into a trained target detection model when collecting the historical image, to recognize an image region in which the target object is located in the historical image, determine an imaging size of the target object in the historical image based on the image region in which the target object is located in the historical image, and then divide the reference parameter by the imaging size. An obtained value is the second distance between the target object and the camera when the terminal collects the historical image for the target object.

In the foregoing embodiment, the second distance and the first distance are determined in the same manner, so that the calculated movement speed can be more accurate.

In an embodiment, the method for processing an identity recognition image further includes: obtaining the target image configured for identity recognition in response to an identity recognition trigger event; performing identity information matching on an identity feature in the target image with prestored identity registration information, to obtain a matching result; and performing identity recognition on the target image based on the matching result, to obtain an identity recognition result of the target image.

The identity recognition trigger event is an event that triggers the identity recognition, and may specifically include, but is not limited to, an operation or an instruction that triggers the identity recognition. For example, in an access control system scenario, when a user needs to pass an access control, an identity recognition event is triggered. For another example, when a user performs a payment at a payment terminal, an identity recognition event is triggered. In addition, the identity recognition may also be applied to an anti-fanning system scenario. For example, in a network game anti-fanning system, an online game time of minors needs to be limited. In this case, when anti-fanning is triggered, for example, when accumulative duration of an online game of a game user reaches a preset duration threshold, identity recognition needs to be performed on the game user. In this case, an identity recognition event is triggered, to determine whether the game user is an adult or whether the game user is a user of a game account, thereby implementing the limit on the online game time of the minors.

In a specific implementation, the identity recognition trigger event is an event that triggers identity recognition performed through a biological feature. The biological feature is a measurable biological feature of a body part of a user, for example, various types of biological features such as a hand shape, a fingerprint, a face shape, an iris, a retina, and a palm. When identity recognition processing is performed based on the measurable biological feature of the measurable body part of the user, biological data collection needs to be performed for the body part of the user, and biological feature extraction needs to be performed for the collected biological data, so that identity recognition can be performed for the user based on the extracted biological feature. For example, if the identity recognition trigger event is triggering identity recognition through a human face, the terminal needs to collect human face data on the face of the user, and perform identity recognition on the user based on collected human face data, such as a human face image. For another example, if the identity recognition trigger event is triggering identity recognition through a palm, the terminal needs to collect palm data on a palm of the user, and perform identity recognition on the user based on collected palm data. The identity registration information is identity information entered when a user performs identity registration in advance, and may specifically include a registration feature image.

When detecting an identity recognition trigger event, for example, detecting that the user performs identity recognition, the terminal obtains, in response to the identity recognition trigger event, a target image configured for performing identity recognition. The target image is determined through the foregoing embodiments. The terminal queries prestored identity registration information, and performs identity information matching on the identity feature image with the identity registration information. Specifically, the terminal may perform image feature matching on the identity feature image with the registration feature image, to perform identity recognition based on the identity feature image. Specifically, the terminal may determine, according to an image feature matching result between the identity feature image and the registration feature image, an identity recognition result based on the identity feature image.

In this embodiment, after determining the target image, in response to the identity recognition trigger event, the terminal performs identity information matching with the identity registration information based on the target image, so that identity recognition is performed based on the target image. In this way, impact on imaging of an image due to an excessively fast target speed can be reduced, and imaging quality of the image configured for identity recognition is ensured, thereby improving the accuracy of the identity recognition.

In an embodiment, the current image is an image collected for a palm part. The identity registration information includes a palm print registration feature and a palm vein registration feature obtained by performing identity registration on a palm of a registered user. The performing identity information matching on an identity feature in the target image with prestored identity registration information, to obtain a matching result includes: extracting a palm print feature and a palm vein feature from the target image; performing palm print feature matching on the palm print feature with the palm print registration feature, to obtain a palm print feature matching result; and performing palm vein feature matching on the palm vein feature with the palm vein registration feature, to obtain a palm vein feature matching result.

The target image is an image obtained by collecting for the palm part, that is, identity recognition is performed through the palm of the user. The palm print registration feature is a palm print feature entered when the registered user performs identity registration by using a palm. The palm vein registration feature is a palm vein feature entered when the registered user performs identity registration by using a palm.

The palm print is an image of the palm from ends of fingers to the wrist, and includes various features such as main lines, wrinkles, fine textures, spinal cord endings, and bifurcation points that can be used for identity recognition. The palm print feature is a feature reflected by texture information of the palm, and may be extracted from a palm image by shooting an image of the palm. Different users generally correspond to different palm print features, that is, palms of different users have different texture features, and identity recognition processing for different users may be implemented based on the palm print features. The palm vein refers to a vein information image of the palm, which is configured for reflecting image information of veins in the palm of a human body. The palm veins have a live body recognition capability, and can be shot by an infrared camera. The palm vein feature is a vein feature of a palm site obtained based on palm vein analysis. Different users generally correspond to different palm vein features, that is, palms of different users have different vein features. Identity recognition processing for different users may also be implemented based on the palm vein feature. The palm print feature matching result is a matching result obtained by performing feature matching based on the palm print feature, and reflects an identification result obtained by performing identity recognition through the palm print. The palm vein feature matching result is a matching result obtained by performing feature matching based on the palm vein feature, and reflects an identification result obtained by performing identity identification through the palm vein.

The terminal may perform feature extraction on the identity feature image, to obtain a palm print feature and a palm vein feature. In specific application, the identity feature image is an image obtained by collection based on a palm part, and may include a visible light image and an infrared image. The terminal performs feature extraction on the visible light image to obtain a palm print feature, and the terminal performs feature extraction on the infrared image to obtain a palm vein feature. The terminal performs palm print feature matching on the palm print feature with the palm print registration feature, to obtain a palm print feature matching result. In a specific implementation, the palm print feature matching may be calculation of a palm print feature similarity, to obtain a palm print feature matching result including the palm print similarity. If the palm print similarity exceeds a palm print similarity threshold, it may be considered that palm print matches are consistent, otherwise, it is considered that the palm print matches are inconsistent. The terminal performs palm vein feature matching on the palm vein feature with the palm vein registration feature, to obtain a palm vein feature matching result. In a specific implementation, the palm vein feature matching may be calculation of a palm vein feature similarity, to obtain a palm vein feature matching result including the palm vein similarity. If the palm vein similarity exceeds a palm vein similarity threshold, it may be considered that palm vein matches are consistent, otherwise, it is considered that the palm vein matches are inconsistent. The terminal obtains an identity recognition result based on the palm print feature matching result and the palm vein feature matching result. For example, the terminal may perform weighted fusion on the palm print feature matching result and the palm vein feature matching result, to obtain the identity recognition result according to a weighted fusion result.

In this embodiment, feature matching is performed based on the palm print feature and the palm vein feature at the palm, to implement identity recognition, and accurate identity recognition can be performed based on the palm image.

In an embodiment, each registered user has an association relationship with a resource transfer account. The method for processing an identity recognition image further includes: determining a resource transfer parameter in response to a resource transfer trigger event; querying the association relationship according to a registered user indicated by the identity recognition result of the target image, to determine a target resource account; and performing resource transfer for the target resource account based on the resource transfer parameter.

The resource is an asset that may be exchanged for a subject matter. The resource may be funds, electronic vouchers, shopping vouchers, virtual red envelopes, and the like. The virtual red envelope is a virtual object with a specific value attribute of funds. For example, funds may be exchanged for goods of equal value after a transaction is performed. The resource transfer is an exchange of resources, including a resource transfer-in party and a resource transfer-out party. Resources are transferred from the resource transfer-in party to the resource transfer-out party. For example, in a payment process of shopping, funds are transferred as resources. A resource transfer trigger event is an event that triggers resource transfer, and may specifically include, but is not limited to, an operation or an instruction that triggers resource transfer, and the like. The resource transfer trigger event may be triggered by a user that needs to perform resource transfer processing, for example, may be triggered by a resource transfer-in party in the resource transfer processing, or may be triggered by a resource transfer-out party in the resource transfer processing. The resource transfer is to transfer a specific quantity of resources owned by the resource transfer-out party to the resource transfer-in party. The resource transfer trigger event may be flexibly set based on actual needs. The resource transfer parameter is a related parameter of to-be-performed resource transfer processing corresponding to the resource transfer trigger event, and may specifically include, but is not limited to, various parameter information such as a resource transfer-in party, a resource transfer-out party, a resource transfer amount, an offer amount, an order number, a resource transfer time, and a resource transfer terminal. The target resource account is a resource account associated with the user that triggers the resource transfer trigger event. A resource transfer operation is performed for the target resource account, so that resource transfer processing for the user may be implemented.

The terminal may determine a resource transfer parameter in response to the resource transfer trigger event, for example, determine a resource transfer amount and a resource transfer-in party. If the user identity corresponding to the user can be determined according to the identity recognition result, the terminal may determine a target resource account associated with the user according to the identity recognition result. Specifically, the terminal may determine the user identity corresponding to the user based on the identity recognition result, and determine the target resource account associated with the user according to the user identity corresponding to the user. The target resource account includes resources of the user. The terminal performs resource transfer for the target resource account based on the determined resource transfer parameter, for example, transfers, according to the resource transfer amount in the resource transfer parameter, the resources in the target resource account to the resource transfer-in party in the resource transfer parameter, thereby implementing resource transfer processing for the user.

In this embodiment, the target resource account is determined based on the identity recognition result, and when the resource transfer trigger event is triggered, the resource transfer processing is performed by using the determined target resource account and according to the corresponding resource transfer parameter, and the resource transfer processing is performed based on the identity recognition result, thereby improving processing efficiency of resource transfer.

This application further provides an application scenario. In the application scenario, the foregoing identity recognition image processing method is applied. In this application scenario, the target object is a palm, and a registered user can pay through palm scanning. The palm scanning is a method of performing identity recognition through recognition of a biometric feature of the palm, such as a palm print feature and a palm vein feature of the palm. In a palm scanning scenario, the palm is close to the camera, and imaging of the palm follows characteristics of a closer object looking larger. Based on the trigonometric function correlation relationship, transformation of a distance between key points in two adjacent images is calculated, and based on a transformation trend, a movement speed of a palm can be estimated.

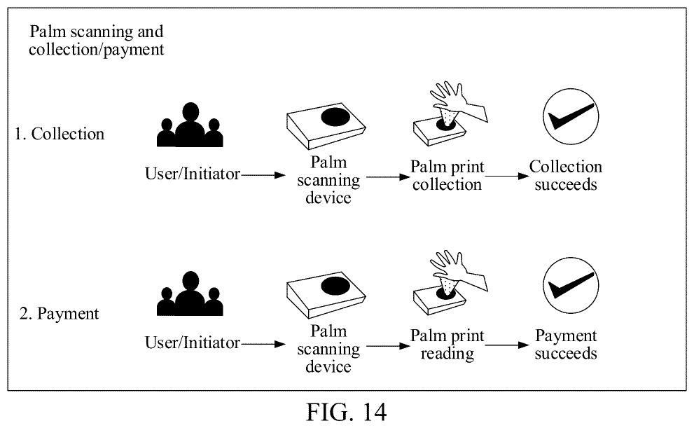

Refer to FIG. 14, this application scenario mainly includes a collection process and a payment process, which are separately described in detail below.

### I. Collection Process

A user (or an initiator) places a palm on a palm scanning device. The palm scanning device is a terminal having a palm scanning function. The terminal performs palm print collection on the palm. After collection succeeds, a target image including the palm print is obtained. A palm print feature and a palm vein feature are extracted from the target image as the palm print registration feature and the palm vein registration feature of the registered user, and an association relationship is established with an identity identifier of the registered user. The identity identifier of the registered user also establishes an association relationship with a payment account of the registered user.

In a process of palm print collection, the terminal performs real-time image collection on the palm. Each image is collected, the collected image is used as a current image, and the following operations are performed.

1. Perform target detection on the current image, to recognize an image region in which a palm is located, and determine an imaging size of the palm in the current image based on the image region in which the palm is located.

The terminal extracts the image region in which the palm is located from the current image, to obtain a to-be-detected image, inputs the to-be-detected image into a trained target key point detection model, predicts an initial key point by using the target key point detection model, crops a region image within a preset range around the initial key point from the to-be-detected image, to obtain a cropped image, enlarges the cropped image according to an imaging size specified by the target key point detection model, to obtain an enlarged image, and inputs the enlarged image into the target key point detection model, to obtain a plurality of candidate key points. The candidate key points may be, for example, a key point 1, a key point 2, a key point 3, and a key point 4 in FIG. 8. Further, the terminal selects two target key points from the plurality of candidate key points. Line segments determined by the target key points satisfy a horizontal direction condition. The target key points may be, for example, a key point 2 and a key point 4 in FIG. 8. In other embodiments, the key points obtained by performing key point detection on the palm may alternatively be other points, for example, key points at knuckles of the fingers. Correspondingly, the selected target key points may be key points that are nearly parallel to the X-axis in the key points at the knuckles of the palm.

Further, the terminal calculates a distance between the target key points, and determines the calculated distance as the imaging size. For calculation of the distance between the target key points, reference may be made to Formula (3).

2. Based on a pre-calibrated reference parameter and the imaging size, determine a first distance between the palm and the camera when the current image is collected, the reference parameter being determined according to a reference size of the palm and a reference distance between the aperture of the camera and the image sensor.

The terminal may divide the reference parameter by the imaging size, to obtain the first distance between the palm and the camera when the current image is collected.

The reference parameter is calibrated through the following operations. It is assumed that after a camera is determined, a distance between an aperture and an image sensor is H. In addition, a difference between palm sizes L of adults is not large, where L is a distance between the key point 2 and the key point 4 on the palm. A standard palm size may be used for calibration. In a calibration process, when the distance between the palm and the aperture is H1 (H1 may be, for example, 3 cm), imaging of the palm in the terminal is L1, and a value of L×H may be obtained by substituting H1 and L1 in Formula (4). When the distance between the palm and the aperture is H2 (H2 may be, for example, 5 cm), imaging of the palm in the terminal is L2, and the value of L×H may be obtained by substituting H2 and L2 in Formula (5). L is the palm size (namely, the reference size representation value in the foregoing), and is a fixed value, and H is also a fixed value. Different distances are changed and a plurality of measurements are performed, and an average of L×H can be obtained. The average is the reference parameter. Assuming that the average is K, it can be obtained that H=K/X, where H is the distance between the palm and the aperture, and X is a size of the palm imaged on the terminal.

4. Obtain a second distance, the second distance being a distance between the palm and the camera when a previous image is collected for the palm.

The second distance may be calculated in the same manner as the first distance.

5. Determine a collection time difference between the current image and the previous image, obtain a distance difference between the first distance and the second distance, and divide the distance difference by the collection time difference, to obtain a movement speed of the palm.

In an actual application, through two adjacent palm images shot by the terminal, the imaging size X of the palm in the two shot adjacent images can be calculated, and is substituted into H=K/X, so that the distance H between the palm and the aperture in the two adjacent images can be calculated, thereby estimating the movement speed of the palm.

6. When the movement speed is less than a speed threshold set by the identity recognition image condition, determine the current image as the candidate image.

7. When the movement speed is greater than or equal to the speed threshold set by the identity recognition image condition, continue to collect a next image, and continue to collect a next image until an image with the movement speed less than the speed threshold set by the identity recognition image condition is collected.

### II. Payment Process

A user (or an initiator) places a palm on a palm scanning device. The palm scanning device is a terminal having a palm scanning function. The terminal reads a palm print on the palm, performs identity recognition based on the read palm print, and performs payment based on an identity recognition result. After the payment succeeds, a payment process ends.

In a process of reading the palm print, the terminal performs real-time image collection on a palm. Each image is collected, the collected image is used as the current image, and the foregoing operations 1 to 7 are performed to obtain the target image. The palm print feature and the palm vein feature are extracted from the target image, palm print feature matching is performed on the palm print feature with the palm print registration feature, to obtain a palm print feature matching result, palm vein feature matching is performed on the palm vein feature with the palm vein registration feature, to obtain a palm vein feature matching result, and the identity recognition result of the target image is obtained according to the palm print feature matching result and the palm vein feature matching result.

In this embodiment, when the current image is collected, the movement speed of the target object satisfies the identity recognition image condition, so that movement blur that occurs in the image configured for identity recognition due to an excessively fast movement speed can be avoided. This improves the quality of the image configured for identity recognition, thereby improving the accuracy of the identity recognition. Further, since the movement speed of the target object in the identity recognition process is estimated without additional hardware such as a distance sensor, avoiding adding an additional distance sensor to the palm scanning device, which reduces costs and facilitates post-maintenance.

This application further provides another application scenario. In the application scenario, the foregoing identity recognition image method is applied. Application of the method for processing an identity recognition image in the application scenario is as follows:

In an access control system scenario, a user may perform identity recognition through an identity recognition device. When it is determined that the user belongs to a legal identity, the user may be allowed to enter through an access control. The identity recognition device is a terminal that can perform identity recognition. The terminal collects an image of a palm part of a user, and performs identity recognition based on a palm image. The user first performs palm print registration. In a registration process, the terminal first collects the target image of the user through the method for processing an identity recognition image provided in the embodiments of this application, extracts the palm print feature and the palm vein feature from the target image as the palm print registration feature and the palm vein registration feature of the registered user, and establishes an association relationship with the identity identifier of the registered user. When the user needs to pass access control, the terminal again collects the target image of the user through the method for processing an identity recognition image provided in the embodiments of this application, extracts the palm print feature and the palm vein feature from the target image. Palm vein feature matching is performed on the palm vein feature with the palm vein registration feature, to obtain a palm vein feature matching result. According to the palm print feature matching result and the palm vein feature matching result, the identity recognition result of the target image is obtained. When the identity recognition result indicates that the user is the registered user, the door lock may be controlled to be opened.

The operations in the flowcharts involved in the foregoing embodiments are displayed in sequence based on indication of arrows, but the operations are not necessarily performed sequentially according to a sequence indicated by the arrows. Unless otherwise explicitly specified in this application, performing of the operations is not strictly limited, and the operations may be performed in other sequences. In addition, at least some operations in the flowcharts involved in the embodiments may include a plurality of operations or a plurality of stages, and these operations or stages are not necessarily performed at a same moment, and may be performed at different moments. The operations or stages are not necessarily performed in sequence, and may be performed in turns or alternately with other operations, or at least a part of operations or stages in the other operations.

Based on the same inventive concept, an embodiment of this application further provides an apparatus for processing an identity recognition image configured to implement the method for processing an identity recognition image. An implementation solution to the problem provided by the apparatus is similar to the implementation solution recorded in the foregoing method. Therefore, for specific limitations in one or more embodiments of the apparatus for processing an identity recognition image provided below, reference may be made to the limitations on the identity recognition image processing method in the foregoing. Details are not described herein again.

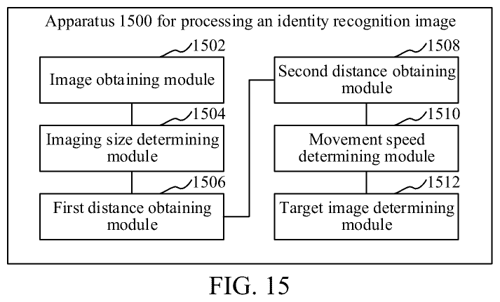

In an embodiment, as shown in FIG. 15, an apparatus 1500 for processing an identity recognition image is provided, including:
an image obtaining module 1502, configured to obtain a current image collected for a target object, the target object including an identity feature;
an imaging size determining module 1504, configured to recognize an image region in which the target object is located from the current image, and determine an imaging size of the target object based on the image region in which the target object is located;
a first distance obtaining module 1506, configured to obtain a reference parameter, and determine a first distance based on the reference parameter and the imaging size, the reference parameter being determined according to a reference size of the target object and a reference distance, the reference distance being a distance between an aperture of a camera and an image sensor, and the first distance being a distance between the target object and the camera when the current image is collected;
a second distance obtaining module 1508, configured to obtain a second distance, the second distance being a distance between the target object and the camera when a historical image is collected for the target object;
a movement speed determining module 1510, configured to determine a collection time difference between the current image and the historical image, and determine a movement speed of the target object based on the first distance, the second distance, and the collection time difference; and
a target image determining module 1512, configured to determine, according to the current image when the movement speed satisfies an identity recognition image condition, a target image configured for identity recognition.

The apparatus for processing an identity recognition image obtains a current image collected for a target object, the target object including an identity feature; performs target detection on the current image to recognize an image region in which the target object is located; determines an imaging size of the target object based on the image region in which the target object is located; determines a first distance between the target object and a camera when the current image is collected based on a pre-calibrated reference parameter and the imaging size, the reference parameter being determined according to a reference size of the target object and a reference distance between an aperture of the camera and an image sensor; obtains a second distance, the second distance being a distance between the target object and the camera when a historical image is collected for the target object; determines a collection time difference between the current image and the historical image; determines a movement speed of the target object based on the first distance, the second distance, and the collection time difference; and when the movement speed satisfies an identity recognition image condition, determines the target image configured for identity recognition according to the current image. Since when the current image is collected, the movement speed of the target object satisfies the identity recognition image condition, movement blur that occurs in the image configured for identity recognition due to an excessively fast movement speed can be avoided, so that quality of the image configured for identity recognition is improved, thereby improving accuracy of identity recognition. Further, since the movement speed of the target object in the identity recognition process is estimated without additional hardware such as a distance sensor. While the accuracy of identity recognition is improved, costs required for identity recognition are further reduced.

In an embodiment, the imaging size determining module is further configured to: detect key points on the image region in which the target object is located, to obtain a plurality of candidate key points; select two target key points from the plurality of candidate key points, and a line segment determined by selected target key points satisfying a horizontal direction condition; and calculate a distance between the target key points, and determine the calculated distance as the imaging size.

In an embodiment, the imaging size determining module is further configured to: extract the image region in which the target object is located from the current image, to obtain a to-be-detected image; input the to-be-detected image into a trained target key point detection model, to obtain an initial key point predicted by using the target key point detection model; crop, in the to-be-detected image, a region image within a preset range around the initial key point, to obtain a cropped image; enlarge the cropped image according to an image size specified by the target key point detection model, to obtain an enlarged image; and input the enlarged image into the target key point detection model, to obtain the plurality of candidate key points.

In an embodiment, the apparatus further includes a first calibration module, configured to: obtain the reference size of the target object, and obtain the reference distance between the aperture of the camera and the image sensor; and calculate a product of the reference size and the reference distance, to obtain the reference parameter.

In an embodiment, the apparatus further includes a second calibration module, configured to: obtain a first calibration image collected by using the camera, the first calibration image being an image collected for the target object at a first calibration distance; recognize the image region in which the target object is located from the first calibration image; determine an imaging size of the target object in the first calibration image based on the image region in which the target object is located in the first calibration image, to obtain a first calibration size of the target object; and calculate a product of the first calibration size and the first calibration distance, to obtain a first product calculation result of the reference size of the target object and the reference distance, and use the first product calculation result as the reference parameter.

In an embodiment, the second calibration module is further configured to: obtain a plurality of second calibration images collected by using the camera, the plurality of second calibration images being images respectively collected for the target object at different second calibration distances; recognize, for each of the plurality of second calibration images, the image region in which the target object is located from the second calibration image; determine an imaging size of the target object in the second calibration image based on the image region in which the target object is located in the second calibration image, to obtain a second calibration size of the target object; calculate a product of the second calibration distance when the second calibration image is collected and the second calibration size, to obtain a second product calculation result of the reference size of the target object and the reference distance; and calculate a product average of second product calculation results, to obtain the reference parameter.

In an embodiment, the target image determining module is further configured to: when the movement speed is less than a speed threshold set in the identity recognition image condition, determine the current image as a candidate image, and determine the target image configured for identity recognition based on the candidate image.

In an embodiment, when the movement speed is greater than or equal to the speed threshold set in the identity recognition image condition, a next image continues to be collected, the collected next image is determined as a current image, and the operation of the recognizing an image region in which the target object is located from the current image is entered.

In an embodiment, the second distance obtaining module is further configured to: obtain the historical image collected for the target object; recognize, from the historical image, the image region in which the target object is located in the historical image, and determine an imaging size of the target object in the historical image based on the image region in which the target object is located in the historical image; and determine, based on the reference parameter and the imaging size of the target object in the historical image, a second distance between the target object and the camera when the historical image is collected.

In an embodiment, the apparatus further includes: an image recognition module, configured to obtain the target image configured for identity recognition in response to an identity recognition trigger event; perform identity information matching on an identity feature in the target image with prestored identity registration information, to obtain a matching result; and perform identity recognition on the target image based on the matching result, to obtain an identity recognition result of the target image.

In an embodiment, the current image is an image collected for a palm part. The identity registration information includes a palm print registration feature and a palm vein registration feature obtained by performing identity registration on a palm of a registered user. The image recognition module is further configured to: extract a palm print feature and a palm vein feature from the target image; perform palm print feature matching on the palm print feature with the palm print registration feature, to obtain a palm print feature matching result; and perform palm vein feature matching on the palm vein feature with the palm vein registration feature, to obtain a palm vein feature matching result.

In an embodiment, each registered user has an association relationship with a resource transfer account. The apparatus further includes: a resource transfer module, configured to: determine a resource transfer parameter in response to a resource transfer trigger event; query the association relationship according to a registered user indicated by the identity recognition result of the target image, to determine a target resource account; and perform resource transfer for the target resource account based on the resource transfer parameter.

In an embodiment, the imaging size determining module is configured to: obtain a trained target detection model, the target detection model being obtained through training by using a training sample, and position information of the target object being calibrated in the training sample; input the current image into the target detection model, and perform target detection on the current image through the target detection model, to obtain position information of the target object in the current image; and recognize, according to the position information of the target object in the current image, the image region in which the target object is located.

All or some of the modules in the apparatus for processing an identity recognition image may be implemented by software, hardware, and a combination thereof. The foregoing modules may be built in or independent of a processor of a computer device in a form of hardware, or may be stored in a memory of the computer device in a form of software, for the processor to invoke to execute operations corresponding to the foregoing modules.

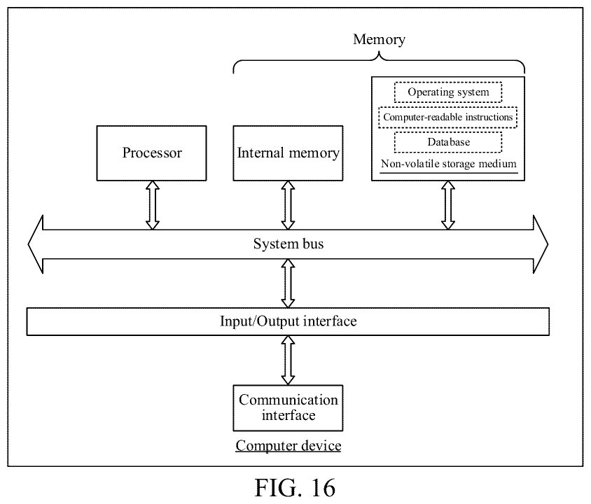

In an embodiment, a computer device is provided. The computer device may be a server, and an internal structure diagram thereof may be shown in FIG. 16. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium has an operating system, computer-readable instructions, and a database stored therein. The internal memory provides an environment for running of the operating system and the computer-readable instructions in the non-volatile storage medium. The database of the computer device is configured to store identity registration information data. The input/output interface of the computer device is configured to exchange information between the processor and an external device. The communication interface of the computer device is configured to connect and communicate with an external terminal through a network. The computer-readable instructions, when executed by the processor, implement a method for processing an identity recognition image.

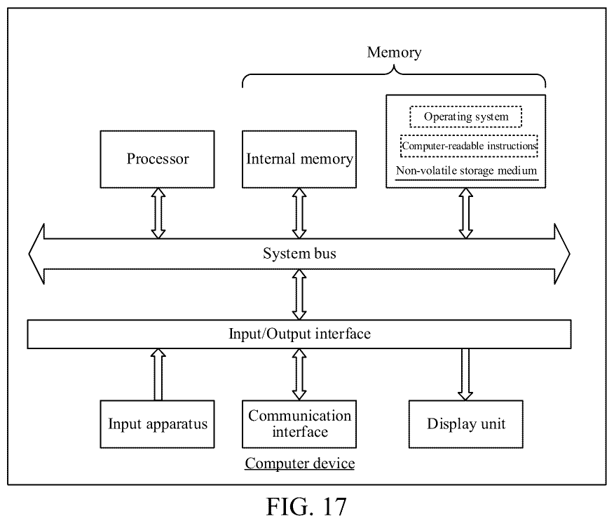

In an embodiment, a computer device is provided. The computer device may be a terminal, and an internal structure diagram thereof may be shown in FIG. 17. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an environment for running of the operating system and the computer-readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented through Wi-Fi, a mobile cellular network, near field communication (NFC), or another technology. The computer-readable instructions, when executed by the processor, implement a method for processing an identity recognition image. The display unit of the computer device is configured to form a visible picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse, or the like.

A person skilled in the art may understand that in the structure shown in FIG. 16 and FIG. 17, only a block diagram of a partial structure related to a solution in this application is shown, and FIG. 16 and FIG. 17 do not constitute a limitation to the computer device to which the solution in this application is applied. Specifically, the computer device may include more or fewer components than those shown in FIG. 16 and FIG. 17, or some components may be combined, or a different component deployment may be used.

In an embodiment, a computer device is provided, including a memory and a processor. The memory has computer-readable instructions stored therein. The processor, when executing the computer-readable instructions, implements the operations of the foregoing method for processing an identity recognition image.

In an embodiment, a computer-readable storage medium is provided. The computer-readable storage medium has computer-readable instructions stored therein. The computer-readable instructions, when executed by a processor, implement the operations of the foregoing method for processing an identity recognition image.

In an embodiment, a computer program product is provided, including computer-readable instructions. The computer-readable instructions, when executed by a processor, implement the operations of the foregoing method for processing an identity recognition image.

User information (including, but not limited to, user equipment information, user personal information, and the like) and data (including, but not limited to, data for analysis, stored data, displayed data, and the like) involved in this application are all information and data authorized by users or fully authorized by all parties, and collection, use, and processing of relevant data need to comply with relevant laws, regulations, and standards of relevant countries and regions.

A person of ordinary skill in the art may understand that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a storage, a database, or another medium used in the embodiments provided in this application can include at least one of a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache memory, or the like. As an illustration rather than a limitation, the RAM is available in various forms, such as a static random access memory (SRAM) or a dynamic random access memory (DRAM). The database involved in the embodiments provided in this application may include at least one of a relational database or a non-relational database. The non-relational database may include a blockchain-based distributed database, or the like, but is not limited thereto. The processor involved in the embodiments provided in this application may be a general-purpose processor, a central processing unit, a graphics processing unit, a digital signal processor, a programmable logic device, a quantum computing-based data processing logic device, or the like, but is not limited thereto.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

The foregoing embodiments merely express several implementations of this application. The descriptions thereof are relatively specific and detailed, but are not understood as limitations to the scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A processing method, performed by a computer device, the method comprising:
obtaining a current image collected for a target object, the target object including an identity feature;
recognizing, from the current image, a target image region in which the target object is located;
determining an imaging size of the target object based on the target image region;
obtaining a reference parameter, the reference parameter being determined according to a reference size of the target object and a reference distance, the reference distance being a distance between an aperture of a camera that captured the current image and an image sensor of the camera;
determining a first distance based on the reference parameter and the imaging size, the first distance being a distance between the target object and the camera when the current image is collected;
obtaining a second distance, the second distance being a distance between the target object and the camera when a historical image is collected for the target object;
determining a collection time difference between the current image and the historical image;
determining a movement speed of the target object based on the first distance, the second distance, and the collection time difference; and
determining, according to the current image, a target image configured for identity recognition in response to the movement speed satisfying an identity recognition image condition.

2. The method according to claim 1, wherein determining the imaging size includes:
performing key point detection in the target image region to obtain a plurality of candidate key points;
selecting two target key points from the plurality of candidate key points, a line segment determined by the selected target key points satisfying a horizontal direction condition; and
calculating a distance between the target key points as the imaging size.

3. The method according to claim 2, wherein performing key point detection in the target image region includes:
extracting the target image region from the current image, to obtain a detection image to be detected;
inputting the detection image into a trained target key point detection model, to obtain an initial key point predicted by using the target key point detection model;
cropping, from the detection image, a region image within a preset range around the initial key point, to obtain a cropped image;
enlarging the cropped image according to an image size specified by the target key point detection model, to obtain an enlarged image; and
inputting the enlarged image into the target key point detection model, to obtain the plurality of candidate key points.

4. The method according to claim 1, wherein the reference parameter is obtained through a calibration operation including:
obtaining the reference size and the reference distance; and
calculating a product of the reference size and the reference distance, to obtain the reference parameter.

5. The method according to claim 1, wherein the reference parameter is obtained through a calibration operation including:
obtaining a calibration image, the calibration image being collected for the target object at a calibration distance;
recognizing, from the calibration image, an image region in which the target object is located;
determining an imaging size of the target object in the calibration image based on the image region in which the target object is located in the calibration image, to obtain a calibration size of the target object; and
calculating a product of the calibration size and the calibration distance, to obtain a product calculation result of the reference size of the target object and the reference distance as the reference parameter.

6. The method according to claim 1, wherein the reference parameter is obtained through a calibration operation including:
obtaining a plurality of calibration images, the plurality of second calibration images being collected for the target object at different calibration distances, respectively;
for each of the plurality of calibration images:
recognizing, from the calibration image, an image region in which the target object is located from the calibration image;
determining an imaging size of the target object in the calibration image based on the image region in which the target object is located in the calibration image, to obtain a calibration size of the target object; and
calculating a product of the calibration distance at which the calibration image is collected and the calibration size, to obtain a product calculation result of the reference size of the target object and the reference distance; and
calculating a product average of the product calculation results, to obtain the reference parameter.

7. The method according to claim 1, wherein determining, according to the current image, the target image in response to the movement speed satisfying the identity recognition image condition includes:
in response to the movement speed being less than a speed threshold set in the identity recognition image condition, determining the current image as a candidate image, and determining the target image based on the candidate image.

8. The method according to claim 7, further comprising:
in response to the movement speed being greater than or equal to the speed threshold, continuing to collect a next image as the current image, and entering the operation of recognizing the target image region from the current image.

9. The method according to claim 1, further comprising:
obtaining the historical image;
recognizing, from the historical image, an image region in which the target object is located in the historical image;
determining an imaging size of the target object in the historical image based on the image region in which the target object is located in the historical image; and
determining, based on the reference parameter and the imaging size of the target object in the historical image, the second distance.

10. The method according to claim 1, further comprising:
obtaining the target image in response to an identity recognition trigger event;
performing identity information matching on an identity feature in the target image with prestored identity registration information, to obtain a matching result; and
performing identity recognition on the target image based on the matching result, to obtain an identity recognition result.

11. The method according to claim 10, wherein:
the current image is an image of a palm;
the identity registration information includes a palm print registration feature and a palm vein registration feature obtained by performing identity registration on a palm of a registered user; and
performing the identity information matching includes:
extracting a palm print feature and a palm vein feature from the target image;
performing palm print feature matching on the palm print feature with the palm print registration feature, to obtain a palm print feature matching result; and
performing palm vein feature matching on the palm vein feature with the palm vein registration feature, to obtain a palm vein feature matching result.

12. The method according to claim 10, further comprising:
determining a resource transfer parameter in response to a resource transfer trigger event;
querying an association relationship according to a registered user indicated by the identity recognition result, to determine a target resource account; and
performing resource transfer for the target resource account based on the resource transfer parameter.

13. The method according to claim 1, wherein recognizing the target image region includes:
obtaining a trained target detection model, the target detection model being obtained through training by using a training sample, and position information of the target object being calibrated in the training sample;
inputting the current image into the target detection model, and performing target detection on the current image through the target detection model, to obtain position information of the target object in the current image; and
recognizing, according to the position information of the target object in the current image, the target image region.

14. A computer device comprising:
at least one memory storing one or more computer-readable instructions; and
at least one processor configured to execute the one or more computer-readable instructions to:
obtain a current image collected for a target object, the target object including an identity feature;
recognize, from the current image, a target image region in which the target object is located;
determine an imaging size of the target object based on the target image region;
obtain a reference parameter, the reference parameter being determined according to a reference size of the target object and a reference distance, the reference distance being a distance between an aperture of a camera that captured the current image and an image sensor of the camera;
determine a first distance based on the reference parameter and the imaging size, the first distance being a distance between the target object and the camera when the current image is collected;
obtain a second distance, the second distance being a distance between the target object and the camera when a historical image is collected for the target object;
determine a collection time difference between the current image and the historical image;
determining a movement speed of the target object based on the first distance, the second distance, and the collection time difference; and
determine, according to the current image, a target image configured for identity recognition in response to the movement speed satisfying an identity recognition image condition.

15. The computer device according to claim 14, wherein the at least one processor is further configured to execute the one or more computer-readable instructions to, when determining the imaging size:
perform key point detection in the target image region to obtain a plurality of candidate key points;
select two target key points from the plurality of candidate key points, a line segment determined by the selected target key points satisfying a horizontal direction condition; and
calculate a distance between the target key points as the imaging size.

16. The computer device according to claim 15, wherein the at least one processor is further configured to execute the one or more computer-readable instructions to, when performing key point detection in the target image region:
extract the target image region from the current image, to obtain a detection image to be detected;
input the detection image into a trained target key point detection model, to obtain an initial key point predicted by using the target key point detection model;
crop, from the detection image, a region image within a preset range around the initial key point, to obtain a cropped image;
enlarge the cropped image according to an image size specified by the target key point detection model, to obtain an enlarged image; and
input the enlarged image into the target key point detection model, to obtain the plurality of candidate key points.

17. The computer device according to claim 14, wherein the reference parameter is obtained through a calibration operation including:
obtaining the reference size and the reference distance; and
calculating a product of the reference size and the reference distance, to obtain the reference parameter.

18. The computer device according to claim 14, wherein the reference parameter is obtained through a calibration operation including:
obtaining a calibration image, the calibration image being collected for the target object at a calibration distance;
recognizing, from the calibration image, an image region in which the target object is located;
determining an imaging size of the target object in the calibration image based on the image region in which the target object is located in the calibration image, to obtain a calibration size of the target object; and
calculating a product of the calibration size and the calibration distance, to obtain a product calculation result of the reference size of the target object and the reference distance as the reference parameter.

19. The computer device according to claim 14, wherein the reference parameter is obtained through a calibration operation including:
obtaining a plurality of calibration images, the plurality of second calibration images being collected for the target object at different calibration distances, respectively;
for each of the plurality of calibration images:
recognizing, from the calibration image, an image region in which the target object is located from the calibration image;
determining an imaging size of the target object in the calibration image based on the image region in which the target object is located in the calibration image, to obtain a calibration size of the target object; and
calculating a product of the calibration distance at which the calibration image is collected and the calibration size, to obtain a product calculation result of the reference size of the target object and the reference distance; and
calculating a product average of the product calculation results, to obtain the reference parameter.

20. A non-transitory computer-readable storage medium storing one or more computer-readable instructions that, when executed by at least one processor, cause the at least one processor to:
obtain a current image collected for a target object, the target object including an identity feature;
recognize, from the current image, a target image region in which the target object is located;
determine an imaging size of the target object based on the target image region;
obtain a reference parameter, the reference parameter being determined according to a reference size of the target object and a reference distance, the reference distance being a distance between an aperture of a camera that captured the current image and an image sensor of the camera;
determine a first distance based on the reference parameter and the imaging size, the first distance being a distance between the target object and the camera when the current image is collected;
obtain a second distance, the second distance being a distance between the target object and the camera when a historical image is collected for the target object;
determine a collection time difference between the current image and the historical image;
determining a movement speed of the target object based on the first distance, the second distance, and the collection time difference; and
determine, according to the current image, a target image configured for identity recognition in response to the movement speed satisfying an identity recognition image condition.
